(19) United States
(12) Patent Application Publication
(10) Pub. No.: US 2008/0255901 A1
(43) Pub. Date: Oct. 16, 2008

(54) Kiosk systems and methods

(76) Inventors: John Stuart Carroll, San Clemente, CA (US); Roger E. Bocox, Granger, IA (US); Charles J. Brower, Irvine, CA (US); Curtis D. Brown, Healdsburg, CA (US)

Correspondence Address: MCCRACKEN & FRANK LLP, 311 S. WACKER DRIVE, SUITE 2500, CHICAGO, IL, 60606, US

(21) Appl. No.: 12/079,384

(22) Filed: Mar. 26, 2008

Related U.S. Application Data
(60) Provisional application No. 60/920,079, filed on Mar. 26, 2007.

(51) Int. Cl. G06Q 30/00; G06Q 99/00; G06Q 10/00

(52) U.S. Cl. 705/7; 705/14; 705/1

(57) ABSTRACT

A kiosk includes a front panel defining an opening in a body and an interactive screen positioned within the opening. A moisture resistant support structure is disposed between the front panel and the interactive screen. A central processing unit is disposed within the body and the central processing unit is operatively connected to the interactive screen.

### BACKGROUND OF THE INVENTION

1. Field of the Invention

The present disclosure relates to the fields of automation and remote communication; more particularly, the present disclosure relates to systems and methods relating to customer interactions at a free-standing point of sale device; yet more particularly, to systems and methods relating to an automated kiosk.

2. Description of the Background of the Invention

There are many types of automated kiosks used to provide information or commercial services to the public. The typical automated kiosk is an electromechanical device that interacts with and provides a user with a service or a consumable. Generally, the kiosk includes a combination of software and hardware components housed in a tamper resistant body. The software performs various functions, such as processing data, controlling hardware, providing security for the kiosk, and the like. The hardware includes, for example and without limitation, a display screen, a touch panel, a dispenser for cash or other consumables, control circuitry, power supplies, speakers, a camera. Typically, some of the hardware is disposed within the kiosk (e.g., power supplies) and some of the hardware is accessible by a user through a front panel of the kiosk (e.g., a cash dispenser). Additionally, some of the hardware is disposed both within the kiosk and accessible by a user through the front panel, for example, a display screen is disposed within the kiosk but the screen is viewable by a user. In addition, the kiosk may include a data storage capability and/or may transfer information over a network to a central server and other kiosks. For example, banking kiosks (ATMs) include software and hardware to allow access to a user's bank account, receive deposits, dispense cash, print receipts, etc.

Outdoor kiosks and other vending or point of sale (POS) devices typically include a steel or aluminum enclosure that is both durable and weather resistant. Some such kiosks also include a display screen for user interaction overlaid with a transparent touch panel that can detect the location of a touch by a finger or device. For outdoor applications, unimpaired operation of the touch panel in the presence of moisture or pooled water is required.

Both resistive and capacitive touch panels are currently in use for POS devices. Resistive touch panels are resistant to moisture and dust; however, because the resistive touch panel operates by deflecting one side of the panel, the panel must be thin and flexible. This degrades the overall durability of the resistive panel and reliability has suffered in outdoor applications due to scratching and puncturing of the panel. A capacitive touch panel, in comparison, requires only a single solid transparent panel, which can be made much more durable than a resistive panel. Current construction techniques employ a gasket between the touch panel surface and the surrounding supportive material, referred to as the front panel. However, when a conductive front panel is used (e.g., stainless steel), moisture buildup can electrically connect the capacitive surface and the conductive front panel causing improper determination of the location of the touch. Additionally, such construction techniques provide a “pry point” allowing insertion of a blade, screwdriver, or pry bar to enter the kiosk for purposes of theft of vandalism. Therefore, a need exists for a durable touch panel that is resistant to the effects of moisture build-up and connected to the kiosk with minimal or no pry points.

In addition, kiosks are commonly provided with a tamper-resistant access door or panel to facilitate service needs, such as replenishing of consumables, routine or preventive maintenance, or complex repair. In some cases, a single level of security, such as that provided by a single mechanical key, allows access for all of these service needs. In other cases, for example, in a kiosk that accepts or dispenses cash, a separately secured interior kiosk compartment is commonly provided. Having two separately secured compartments can provide access to the kiosk electromechanical components for maintenance or repair and/or to cash storage areas, as one example.

An undesirable result of having a single secured compartment for maintenance and repair is that a user who is only authorized to perform simple maintenance tasks is nonetheless able to access delicate electromechanical components and cash mechanisms. A structure and system that provides access to a user to the appropriate kiosk compartment(s) adequate to his or her training and authority would be a desirable improvement in this art.

Kiosks are commonly secured to an operating location where they are left unattended, and accessed by users to provide information and/or perform transactions for services and/or consumables. Such actions are preferably performed without the need for human assistance. However, at times, the software and/or hardware components of the kiosk may malfunction and the kiosk may not operate as intended. In addition, a user may require assistance to complete a transaction or may wish to communicate a problem or concern, such as when an ATM has not dispensed the correct amount of cash or has failed to return an ATM card. In these situations and others, service providers have designed kiosks to incorporate varying levels of assistance to the user. For example, a kiosk may display a customer support number for the user to call and report a problem. Other kiosks provide an integrated microphone, speaker, and communications connection to call and interact with an operator or support staff. Still other kiosks allow the operator or support staff to initiate communication with the user if a problem is detected or suspected. Additionally, some kiosks offer interactive help programs that can be either online or offline. Other examples include kiosks that are configured to perform self-diagnostics and can communicate data to and from a central server and/or support staff. However, the customer support systems in prior kiosks do not efficiently incorporate various levels of assistance and communication for one or more kiosk and one or more service providers.

Kiosks are used today in a wide variety of commercial settings. One use in particular is associated with gas stations and car washes. In some cases, the kiosk is incorporated into a gas pump that allows a user to pay for the gas and/or to purchase a car wash at the pump. The car wash can also be purchased at a point of sale (POS) location in the store or at an activation unit at a car wash appliance. After the car wash is purchased, the user can drive up to the car wash appliance, enter a code or swipe a card, and proceed to have the car wash performed. In most situations, the user is given a limited amount of time to consummate the sale and have the car wash performed, typically a few days. In addition, the car wash must be completed at the location where it was purchased. However, these prior systems do not allow a user to purchase a car wash at different locations and have the car wash performed at any number of different locations without the need for human assistance.

### SUMMARY OF THE INVENTION

According to a one embodiment, a kiosk includes a front panel that defines an opening in a body and an interactive screen positioned within the opening. A moisture resistant support structure is disposed between the front panel and the interactive screen. A central processing unit is disposed within the body and the central processing unit is operatively connected to the interactive screen.

According to another embodiment, a method of providing customer support at a point of sale includes the steps of providing an activation unit for a customer to select a transaction and providing a product dispenser. The product dispenser is communicatively connected to the activation unit. The method further includes the steps of authorizing the product dispenser to dispense a product based on the selected transaction and providing a server that monitors the activation unit and the product dispenser. Furthermore, the method includes the steps of sensing a need for customer assistance at the activation unit or the product dispenser and providing customer assistance to the customer.

According to yet another embodiment, a method of selling a car wash includes the steps of providing a first car was appliance and a first activation unit at a first location and providing a second car wash appliance and a second activation unit at a second location that is different from the first location. Further, the method includes the steps of providing a first point of sale system at the first location and providing a central server that is communicatively connected with the first and second car wash appliances, the first and second activation units, and the first point of sale system.

### BRIEF DESCRIPTION OF THE DRAWINGS

FIG. 1A is a perspective view of a kiosk according to an embodiment;

FIG. 1B is a front elevational view of the kiosk of FIG. 1A;

FIG. 1C is a left side elevational view of the kiosk of FIG. 1A;

FIG. 1D is an isometric cross-sectional view along lines 1D-1D of the kiosk of FIG. 1A;

FIG. 1E is an isometric cross-sectional view along lines 1E-1E of the kiosk of FIG. 1A;

FIG. 1F is an isometric cross-sectional view along lines 1F-1F of the kiosk of FIG. 1A;

FIG. 1G is an isometric cross-sectional view along lines 1G-1G of the kiosk of FIG. 1A;

FIG. 1H is an enlarged isometric cross-sectional view along lines 1H-1H of the kiosk of FIG. 1A;

FIG. 2 is a flowchart of a process of logging access to secured areas of a kiosk;

FIG. 3 is a block diagram of the electrical components in the kiosk;

FIG. 4 is a block diagram of a remote customer assistance system;

FIG. 5 is a block diagram of a remote customer assistance system including a central server;

FIG. 6 is a block diagram of a system for purchasing and performing a service;

FIGS. 7A-7C depict a perspective view, composite front and side view, and bottom plan view of a kiosk in accord with an embodiment of a kiosk;

FIG. 8 is a simplified semi-schematic block level diagram of a system architecture in accord with the present disclosure;

FIG. 9 is a simplified semi-schematic block level diagram of the component portions of an edge server;

FIG. 10 is a simplified semi-schematic block level diagram of a central server coupled to a multiplicity of edge servers over a wide area communication network;

FIG. 11 is a simplified semi-schematic block level diagram of the component portions of a central server;

FIG. 12 depicts an additional embodiment of the component portions of a central server;

FIG. 13 is a tabular depiction of the communication couplings between the component parts of the system of the present disclosure; and

FIGS. 14A and 14B illustrate how video or still cameras may be disposed at an automated fueling or carwash facility.

### DETAILED DESCRIPTION OF THE PREFERRED EMBODIMENTS

The present disclosure generally relates to a point of sale (POS) device that performs automated and interactive functions. For example, the POS device preferably includes sensors to detect when a user is adjacent thereto, which sensors in turn preferably trigger a communication device to request of the user (i) a code relating, for example, to a prepurchased service or product, or (ii) to make a choice of a service or product that can be purchased at that time. Accordingly, the POS device is preferably a combination of a multiplicity of components directed at, without limitation intended, the following capabilities: sensing, communications (both with respect to receiving and providing, whether offline locally at the POS device or online remotely with other communications devices or human operators), recording (e.g., optimal images relating to the user, the user's vehicle (as in its license plate, for example), or identifying features of place and time of interaction with the user; price; transaction; or the like); change making; and more.

The POS device used in the context of the present disclosure is commonly referred to as a “kiosk,” however, the term kiosk is not intended to imply or define any particular geometry or design, arrangement, collection of features, or other particular characteristic or set of characteristics apart from it having an ability to be accessed by a user to provide information or commercial services. The kiosk of the present disclosure preferably includes: a main body supporting the overall structure of the kiosk and enclosing a multiplicity of internal components, means for attaching the kiosk securely to a location, a front panel, communications components, printer(s), memory device(s), a processor or processors, and locking mechanisms that secure each of the components.

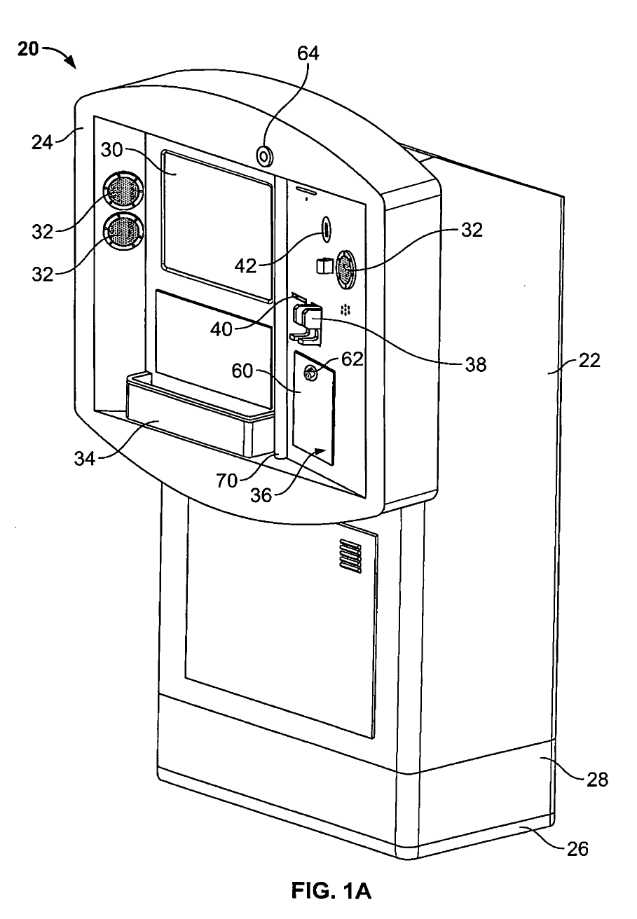

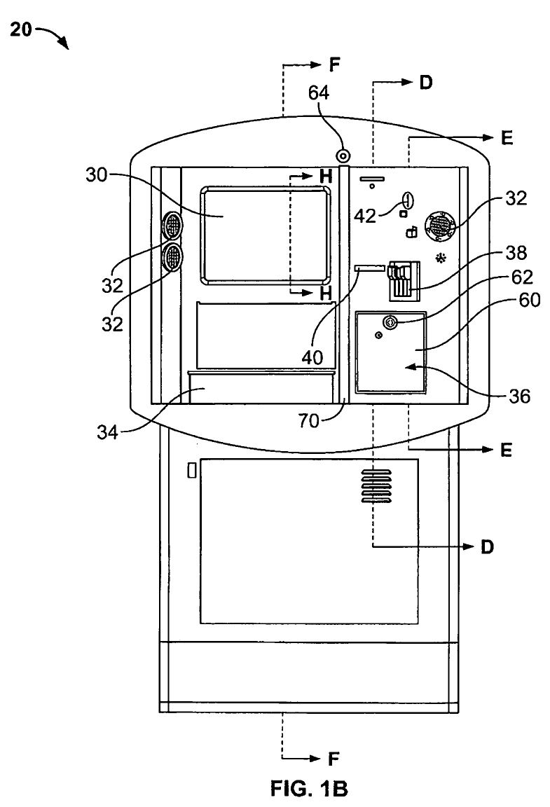

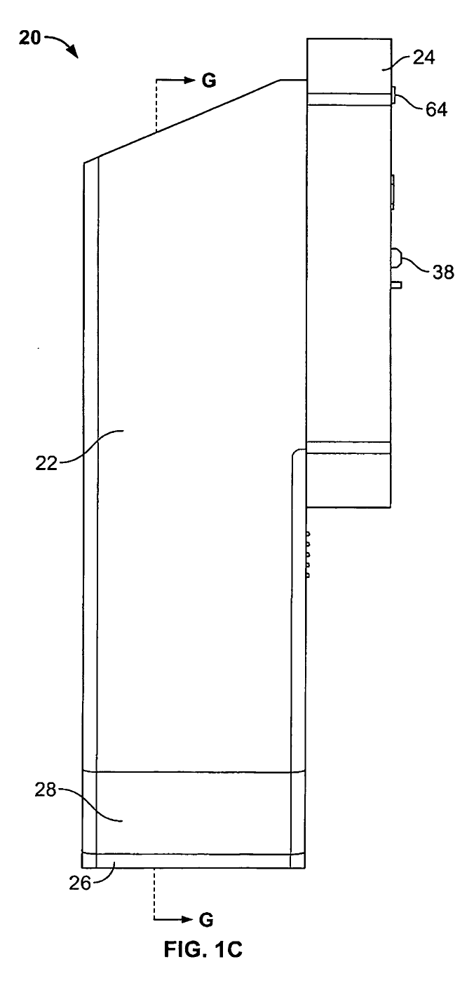

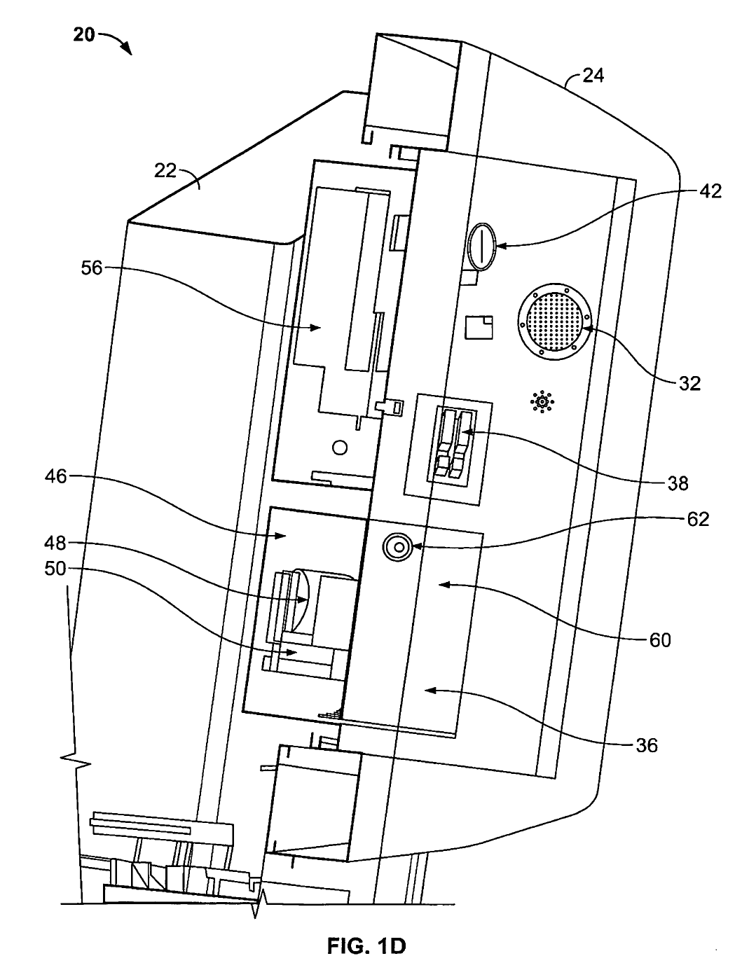

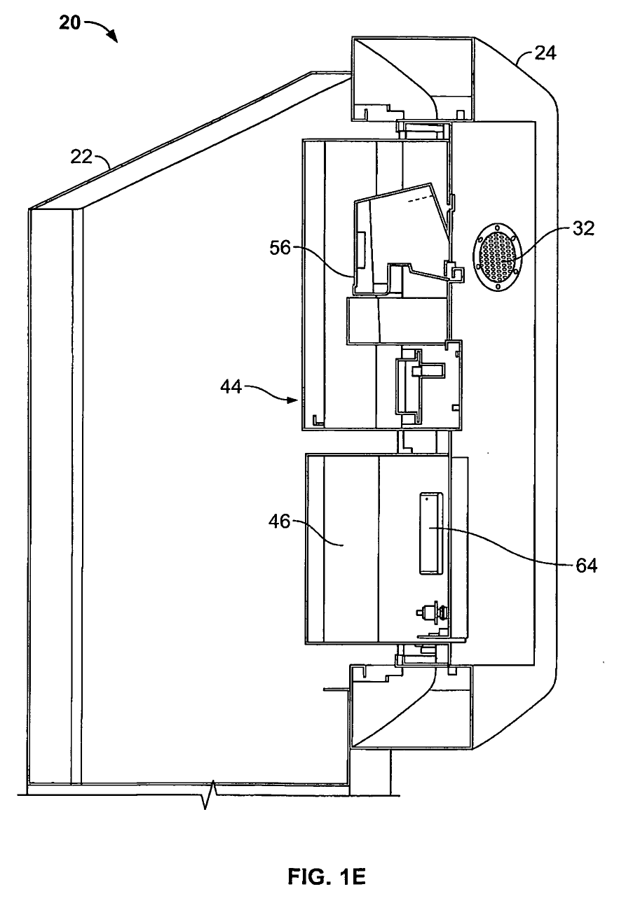

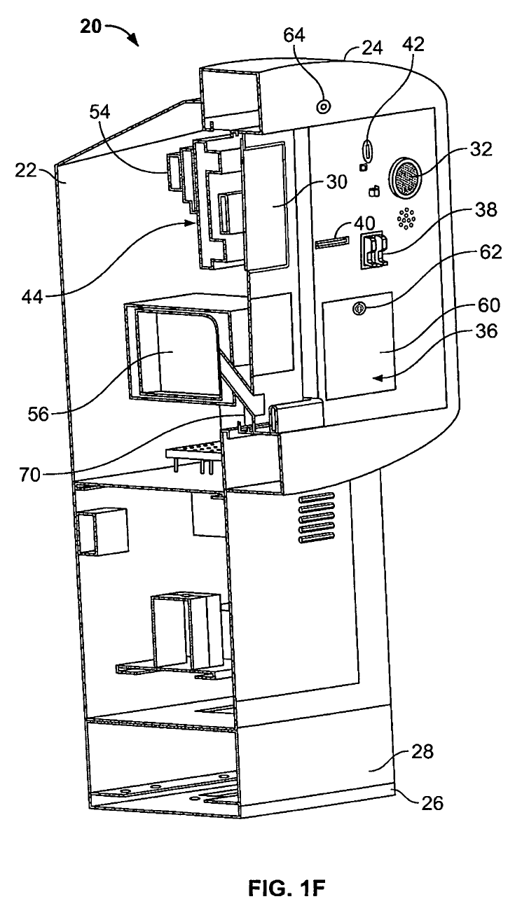

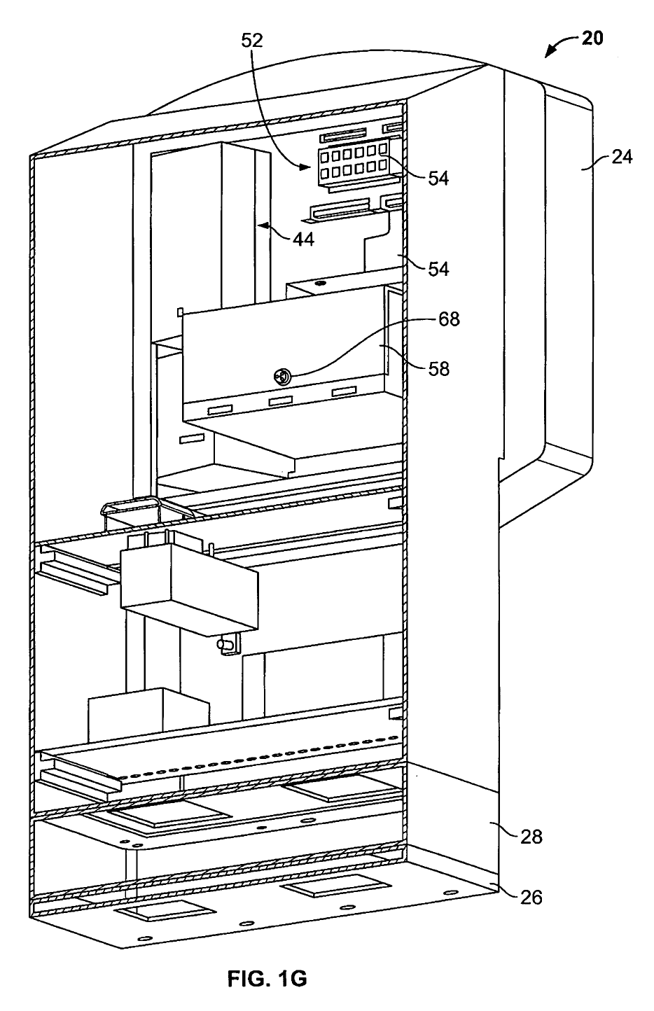

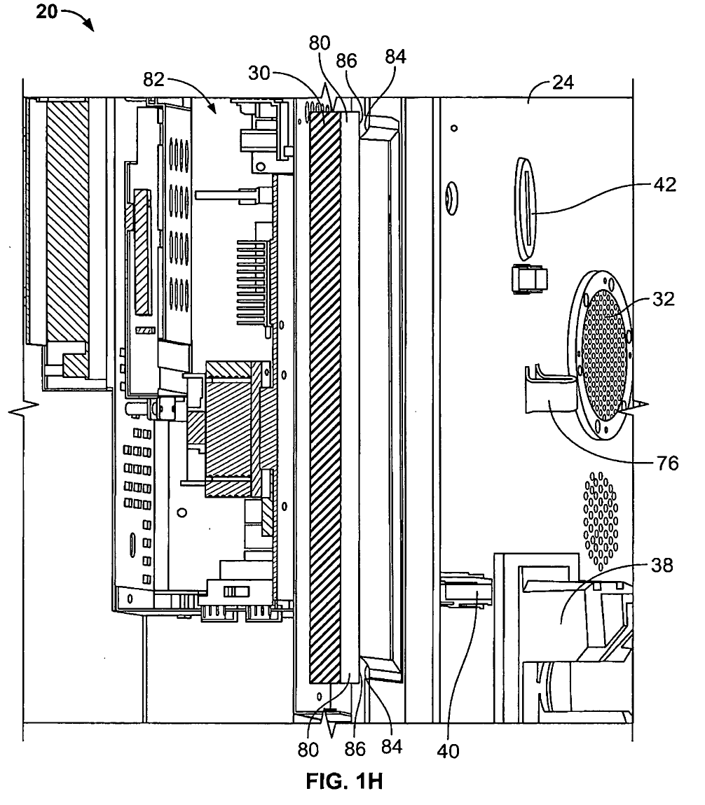

FIGS. 1A-1H show an embodiment of a kiosk 20 including a main body 22, a front panel 24, an adjustment plate 26, and a curb plate 28. The kiosk 20 is secured by the adjustment plate 26 to an operating location where the kiosk is to be secured, for example, inside or outside a store, on a curb, etc. The adjustment plate 26 includes suitable screws, nuts, bolts, and other attachment mechanisms (not shown) to secure the kiosk 20 to the operating location. In one embodiment the kiosk 20 is welded via the adjustment plate 26 to a metal base that secures the kiosk to the location. The curb plate 28 is a structure that can be used to raise the kiosk 20 off of the ground to a comfortable user level when the kiosk is not placed on a curb or other raised structure.

The front panel 24 is attached to the main body 22 of the kiosk 20 and includes components through which a user and the kiosk interact with each other. For example, the front panel 24 can include any or all of the following: a display screen 30, speakers 32, a dispensing tray 34 where money and/or consumables are dispensed, a receipt printer 36, a card swipe 38, a bill acceptor 40, and a coin acceptor 42. The front panel 24 may include other components, as appropriate, such as, without limitation, a microphone 72, a camera 74, a change return 76, or a second display screen (not shown). The components are accessed by opening the front panel 24, which swings away from the main body 22 of the kiosk 20 about a hinge (not shown), to access the back 44 (seen more clearly in FIG. 1G) of the front panel where the electrical and mechanical components are easily accessed.

In one embodiment, the kiosk 20 preferably includes multiple secured areas (also referred to as compartments). The secured areas can be respectively for: (i) electrical and/or mechanical components, (ii) receptacles for consumables, (iii) receptacles for cash, or (iv) other kiosk components or consumables. Each secured area is preferably distinct from the other areas and is associated with one or more specific security levels. Users with appropriate authorization to access one of the secured areas will preferably have the responsibility to inspect or perform certain tasks commensurate with that security level; additionally, such a user can have the responsibility for inspection or performing tasks commensurate with lesser security levels and associated secured compartments. In addition, access to the components in each secured area is preferably commensurate with the training level of the users authorized for each security level. For example, users with a low security level authorization, such as a typical site attendant, are allowed access to a first secured area to perform a limited number of tasks including, for example, performing preventative maintenance or routine service, and replenishing consumables. A second secured area can be associated with a medium security level, for example, that is associated with a higher degree of training and responsibility. In one embodiment, the second secured area (or areas) preferably includes the software or hardware or both software and hardware that controls the operation of the various components of the kiosk. In this embodiment, the second secure area can include the display screen 30, the speakers 32, the card swipe 38, and the like; and further include hardware for the dispensing of cash, consumables, and/or other products. Users with a medium security level authorization preferably have the required training to perform complex maintenance, such as software and hardware installation, repair, replacement, and troubleshooting. More preferably, the second secured area is accessed only at the request of others. For example, access to the second secured areas can be limited to a scheduled service call. Alternatively, access to the second secured area can be limited to times when access to a third secured area is scheduled. A third secured area is preferably associated with a high security level and may include access to cash and/or other components that allow for the performance of sensitive management functions. Such sensitive management functions can include the setting/resetting of security codes, for example. Accordingly, access to the third secured area is allowed for only trusted personnel with the specific training to perform management functions, such as the removing and replenishing of cash.

Referring to the embodiment depicted in FIGS. 1A-1G, a first secured area 46 (seen more clearly in FIG. 1D) is preferably associated with a low security level for standard maintenance functions. Such functions include replacing, for example, a receipt roll 48 and servicing a receipt printer 50. A second secured area 52 is preferably accessed from the inside of the kiosk 20. The second secured area 52 preferably includes software and hardware components 54 connected to the front panel 24. In one embodiment, the second secured area is accessed by opening the front panel 24. A third secured area 56 is also preferably accessed from inside the kiosk 20. More preferably, the third secured area 56 is accessed from inside the second secured area 52. The third secured area 56 preferably includes, for example, cash receptacles 58 that are located inside the main body 22 of the kiosk 20 and further attached to the front panel 24. In yet another embodiment, additional secured areas are contemplated that further segregate components requiring different skill sets for maintenance/repair or having different levels of sensitivity or provide different individuals with different responsibilities as a further security measure.

In one embodiment, one or more keys are used to open locks on doors or panels to selectively allow access to the secured areas. For example, access can be allowed to the first secured area only, the first and second secured areas, the second secured area only, the first and third secured areas, all secured areas, etc. For example, in FIGS. 1A-1G the first secured area 46 is secured behind a first panel 60. A first level key is used to unlock a low security level lock 62 on the first panel 60. Once the low security level lock 62 is unlocked, the first panel 60 can be opened to allow access to the first secured area 46 where the components supporting routine maintenance functions are located. For example, as seen more clearly in FIG. 1D, the first panel 60 leads to the paper roll 48 and the printer 50.

Further, in the embodiment depicted in FIGS. 1A-1G, the second secured area 52 is accessed by swinging open the front panel 24 to access the software and hardware components 54 inside the kiosk 20. The front panel 24 swings open about a hinge (not shown) that is inaccessible from the outside of the kiosk 20 when the front panel 24 is closed. Further, the front panel 24 is preferably secured to the main body 22 of the kiosk 20 by a medium security level lock 64 (best seen in FIG. 1E) that is located inside the first secured area 46. A second level key is used to unlock the medium security level lock 64 and swing open the front panel 24 to expose the software and hardware components 54. In another embodiment, the second level key is also used to unlock a medium security level lock 64 located on the front plate 24 to disengage a security bar 70 that further secures the front plate to the kiosk 20. In yet another embodiment, the second secured area 52 is secured by only the medium security level lock 64 and the security bar 70.

Swinging open the front panel 24 also provides access to the cash receptacles 58 containing the cash. In FIGS. 1A-1G, the cash receptacle 58 is attached to the front panel 24 and swings away from the main body 22 of the kiosk with the front panel. A third level key is used to unlock a high security level lock 68 on the cash receptacle 58. Thereafter, the cash receptacle 58 can be opened to remove and/or replace cash or the entire cash receptacle can be removed.

This arrangement of locks and secured areas provides a multi-level security system wherein access to secured areas that are associated with higher security levels preferably requires access to secured areas that are associated with lower security levels. For example, access to the cash receptacles 58 requires access to the first and/or second secured areas 46, 52. This type of arrangement provides a “ringed” security system that allows a level of access appropriate to a user's training and responsibility, and no more.

In another embodiment, each of the first, second, and third level keys is preferably part of a master key system, so that the first level key opens only low security level locks, the second level key opens both medium and low level locks and the third level key opens high security level, medium level, and low level locks. As a result, each user only needs to carry one key to access the secured area appropriate to his/her security level or responsibility.

Any key and matching locking mechanism may be used. For example, all known types of mechanical keys, all known types of electro-mechanical keys such as RFID-tagged keys and magnetic-encoded keys, and all other suitable keys as may be developed may be usefully employed. Other suitable keys may include a fingerprint, retinal scan, and other biometrics. Specifically, suitable keys are those that specifically unlock one or more locking mechanisms. The locking mechanisms include such locks as padlocks, combination locks, deadbolts, solenoids, magnetic locks, biometrics scanners, etc. Consequently, in some embodiments the key will not be a physical key, such as with a combination lock.

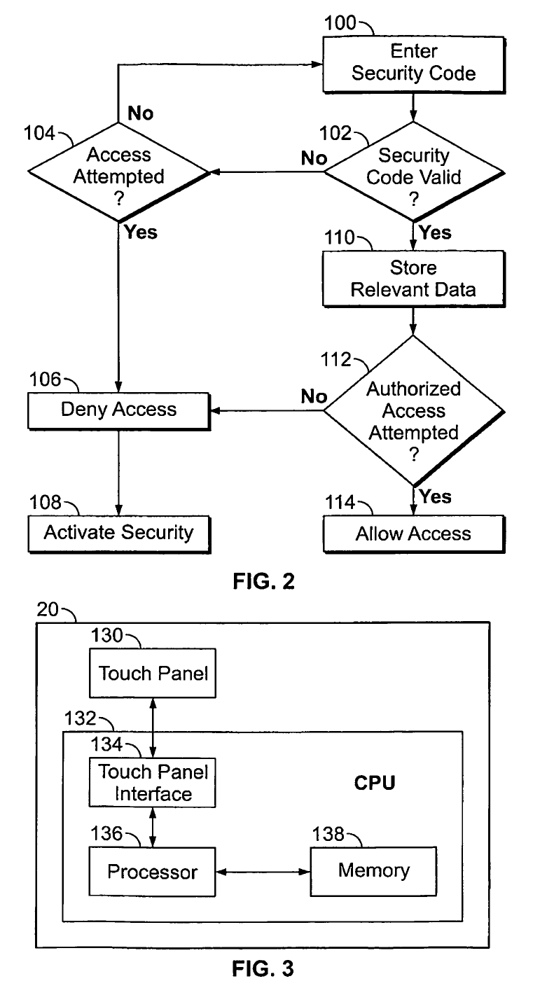

In yet another embodiment, a logging mechanism is provided with the kiosk so that each user with a key also has a security code. For example, the logging mechanism may be a keypad, a touch panel, or a mechanism for scanning a barcode or sensing a RFID tag. FIG. 2 shows one embodiment of a process for authorizing access to the secured areas of the kiosk based on an access key, as described above, in combination with a security code. At a block 100, a user enters a security code. Preferably, the security code is entered through a touch panel prior to using the access key to unlock the respective security level locks. Control then passes to a decision block 102 that determines whether the entered security code is valid. If the security code is not valid, such as if there was a mistake in entering the code or if someone was trying to gain unauthorized access to the kiosk, then an error message is displayed and control passes to a decision block 104. At the decision block 104, the process determines whether someone is trying to access the kiosk by using an access key or otherwise trying to break into the kiosk. In one embodiment, the kiosk is equipped with sensors to detect the attempted access; for example, a sensor can detect whether an object is being inserted into a key slot and/or someone is attempting to pry the kiosk open or move the kiosk. If no attempted access is detected, then control returns to the block 100, and a user may enter/re-enter a security code. However, if an unauthorized attempted access is detected, then control passes to a block 106 and access is denied. Following the block 106, an “activate security” block 108 may activate a security measure, for example, a silent or an audible and/or visual alarm. The block 108 may also notify appropriate law enforcement officials of the attempted unauthorized access attempt. In another embodiment, the security measure activates a camera in the kiosk to take a picture of the unauthorized user.

In yet another embodiment, the process skips the block 104 of determining whether someone is trying to gain unauthorized access to the kiosk and control passes directly from block 102 to blocks 106 and 108 when an invalid code is entered.

Control passes to a block 110 if a valid security code is entered at the block 102. The block 110 stores relevant data into non-volatile memory inside the kiosk 20 and/or the data are sent to a central server and stored. The stored data includes, for example, data identifying the individual associated with the security code, a time of day, duration of access, a security level authorization of the individual such as only low level, low and medium levels, all security levels, only high level, etc. In addition, the kiosk may be equipped with other data capture components, for example, a video camera that records video and/or takes still photos of the user.

Thereafter, a decision block 112 determines whether an authorized access is being attempted. For example, in one embodiment, the relevant data stored by the block 110 includes a security level authorization, which is used at the block 112 to only allow access to the authorized area(s) even if the individual has the appropriate key(s) for the other area(s). If an unauthorized access attempt is detected, for example, when a user only authorized to access the first secured area attempts to further access the second secured area, then control passes to the “deny access” block 106 and to the “activate security” block 108. In another embodiment, the block 112 detects whether a user authorized only to perform management functions is attempting to perform complex maintenance functions. For example, if a user who is only authorized to access the cash storage receptacle is attempting to tamper with the software and hardware components, then control will pass to blocks 106 and 108. In yet another embodiment, access to certain areas is allowed only during certain times of the day or during special circumstances. For example, the management function of removing cash may be allowed only for a short time period each day, such as at the beginning or end of the day, or both. In addition or in the alternative, access for complex maintenance functions may be allowed only in the event of a service call that is recorded and communicated to the kiosk. As a result, the process of FIG. 2 ensures that only users with the proper authorization and training are allowed to access specific secured areas.

Otherwise, if an authorized access is attempted then control preferably passes to a block 114 and access is allowed to the secured area. In this case, no alarms are activated; however, in one embodiment, a picture is taken of the user. In yet another embodiment, the validated security code is not assigned to a specific security level authorization and the user can access any of the secured areas with the appropriate key(s).

The process discussed in connection with FIG. 2 contemplates a kiosk that has both electronic and mechanical mechanisms for selectively allowing access to secured areas. For example, if a user without the proper authorization attempts to open a lock to a secured area with a key, then an electronic mechanism denies access to the secured area. In other embodiments, only mechanical mechanisms are contemplated, wherein an unauthorized user is only able to access the secured area with the proper key. However, in such cases, the process of FIG. 2 is applicable to activate security according to the block 108.

In yet another embodiment, the process of FIG. 2 is implemented without a physical key. For example, access is allowed if a valid security code is entered at block 102 and the relevant data is stored at the block 110. If an invalid security code is entered then access is denied at the block 106. Security may or may not be activated at the “activate security” block 108. For example, in one embodiment, security is only activated if an attempted access is detected.

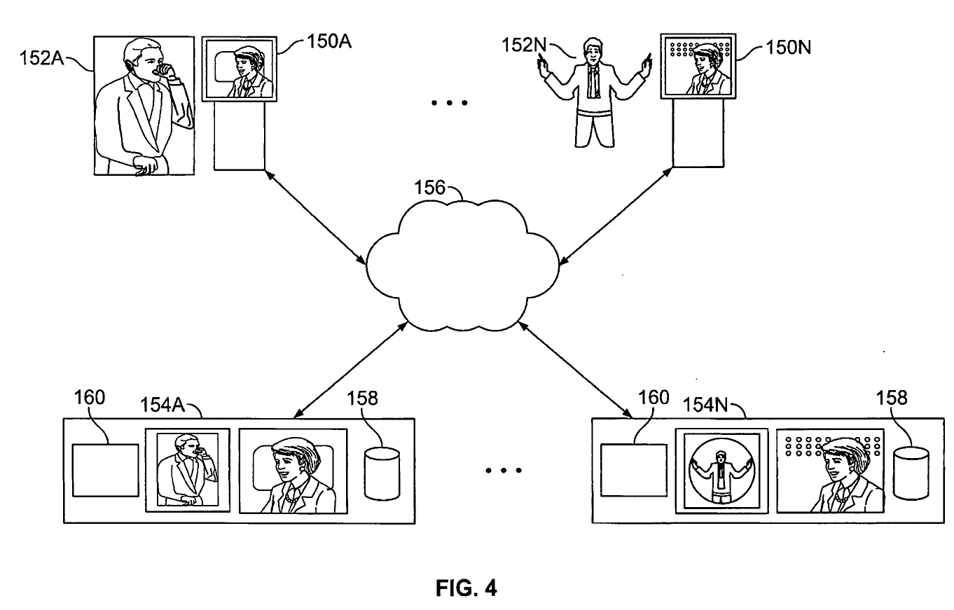

FIG. 3 shows one embodiment of hardware that can implement the software of FIG. 2. The hardware preferably is located inside the kiosk 20, and includes a logging mechanism, such as a touch panel 130 that is coupled to a central processing unit (CPU) 132. The CPU 132 preferably includes a touch panel interface 134 that detects the entry of a security code on the touch panel 130 and communicates the security code to the CPU 132. The CPU 132 is coupled to a memory 136 that stores valid security codes and other relevant data. If desired, the interface 134 and/or the memory 136 may be included in the CPU 132. The CPU 132 compares the security code with valid security codes stored in the memory 136. If the security code is valid then the CPU 132 can store additional relevant data into the memory 136, such as a user name, time of day, length of access, etc. The CPU 132 can also allow access, deny access, and activate security as required by the software.

In a further embodiment, a kiosk adapted for outdoor use is constructed of weather resistant materials and is further sealed from the elements to protect hardware and software components inside the kiosk. Further, the kiosk is preferably tamper resistant so that the physical and electrical components are secure from unauthorized access. For example, any screws and hinges are only accessible from the inside secured areas of the kiosk 20.

In another embodiment as depicted in FIG. 1H, a kiosk preferably includes the display screen 30 positioned in an opening defined by the front panel 24 of the kiosk 20. A touch panel 80 is included, preferably positioned in front of the display screen 30 and connected to control circuitry 82 that detects the location of a touch on the touch panel. In another embodiment, the control circuitry also detects other characteristics of the touch, including the pressure of the touch or biometric such as a fingerprint. The touch panel 80 preferably used in the context of this or any other embodiment disclosed herein may be any type of touch panel, such as resistive, capacitive, surface wave, infrared, strain gauge, and the like. Preferably, the touch panel is resistive or capacitive. More preferably, the touch panel is capacitive. In addition, the touch panel 80 is adapted to sense the location of a touch from any appropriate contact, as when, a human finger or a conductive pen contacts the panel. The display screen 30 displays information to a user, such as account information, sales information, etc. The detected position of a touch on the touch panel 80 preferably corresponds to information displayed on the display screen 30. As a result, the combination of the display screen 30 and the touch panel 80, in one embodiment, provides an interactive display for a user to navigate the menus and options provided by the kiosk 20.

In the embodiment depicted in FIG. 1H, the capacitive touch panel 80 is preferably connected to a support structure 84 and the support structure is connected to the front panel 24 of the kiosk 20. Preferably, the support structure 84 is made of any durable non-conductive or electrical insulator type material, such as wood, rubber, polycarbonate, etc. In addition, the front panel 24 of the kiosk 20 is preferably made of any durable weather resistant material, for example, stainless steel, aluminum, or plastic. The front panel 24 of the kiosk 20 may or may not be a conductive material. However, typically a conductive durable metal is used because of its weather resistance and durability characteristics. The support structure 84 may be connected to the front panel in any suitable manner, including, for example, welding, glue, screws, etc. or any combination of such securing devices or protocols. Further, a gasket 86 is preferably placed between the capacitive touch panel 80 and the front panel 24 to produce a moisture resistant seal. In one embodiment, the gasket 86 is positioned between the touch panel 80 and the support structure 84. The gasket 86 can be any type of common gasket, such as one made of paper, rubber, silicone, metal, felt, fiberglass, plastic polymer, etc. In some cases, such as when a moisture absorbent material is used, the gasket is preferably further coated with a moisture resistant coating (e.g., a paper gasket with a silicone coating).

The support structure in the embodiment of FIG. 1H provides a non-conductive barrier between the front panel 24 and the capacitive touch panel 80. In addition, the non-conductive support structure 84 is preferably constructed to minimize the likelihood that pooling or flowing water or other moisture will bridge the barrier between the front panel and the touch panel, which would impair the ability of the control circuitry 82 to detect the location of a touch. For example, in one embodiment, the support structure 84 is a raised or an indented structure that maintains the touch panel 80 in a plane that is preferably outside of the plane of the front panel 24. Further, in another embodiment, the support structure 84 and/or the front panel 24 include one or more grooves or channels that are suitably positioned to harness gravity and direct the flow of moisture away from the touch panel 80.

In yet another embodiment, the support structure 84 is preferably connected to the touch panel 80 along the periphery of the touch panel 80. More preferably, the support structure 84 overlaps the touch panel along a portion of the front and/or back of the touch panel. This arrangement increases the strength of the interface between the touch panel 80 and the kiosk 20. Further, by controlling the yield strength (a well known term in the art) of the support panel 84, any residual pry points may be further reduced, and preferably eliminated, by the combination of the front panel 24, support panel 84, gasket 86, and touch panel 80.

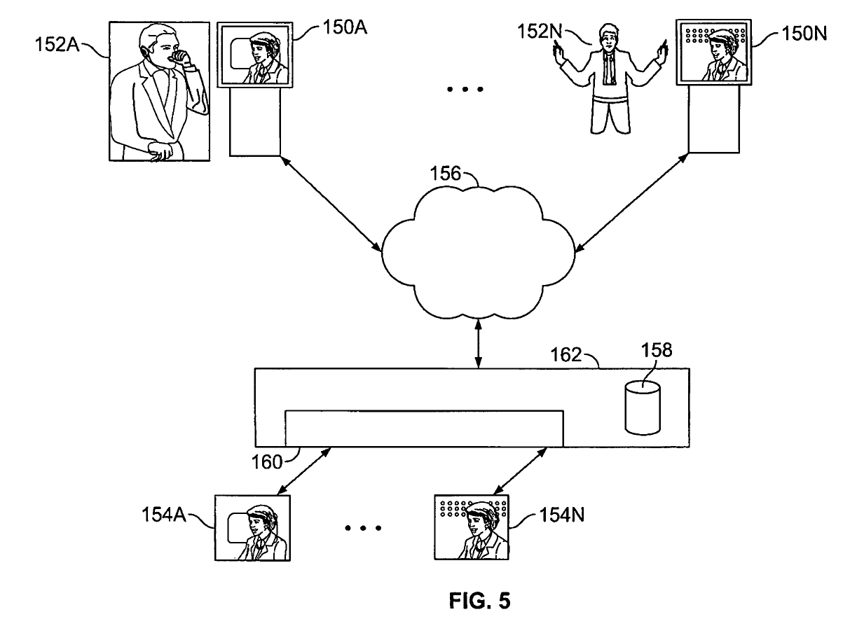

In another embodiment shown in FIG. 4, a kiosk 150 is secured to an operating location and is intended to operate preferably without the need for frequent maintenance and customer support. However, problems may arise with the software and hardware components of the kiosk 150 and/or with a user 152 that is interacting with the kiosk that necessitate assistance. Such assistance is preferably provided by a service provider 154 that can monitor remotely the status of the kiosk 150 and provide interactive assistance to a user 152 at the kiosk. The service provider 154 may be either remote or on-site, albeit not necessarily in sight of the kiosk. Preferably, the service provider 152 is remote, which conserves the resources of the service provider by allowing the service provider to remotely manage multiple kiosks 150 variously located. In a preferred embodiment, the interactive assistance includes providing live support through video and/or audio communications, virtual attendants with computer synthesized characteristics, and/or interactive help menus. More preferably, the system of FIG. 4 is capable of communicating any combination of live video images, real time audio, interactive text messaging, remote diagnostic and control information, and any other form of information bidirectionally between the kiosk 150, the user 152, and the remote service provider 154.

FIG. 4 shows an embodiment of a system that includes one or more kiosks 150A-150N that are connected to one or more remote service providers 154A-154N via a communication connection 156. The communication connection 156 can be wired or wireless and can include, for example, a telephone line, an internet connection, a satellite connection, etc. The kiosks 150 and the service providers 154 transfer information between each other via the communication connection 156. In a preferred embodiment, the information transferred via the communication connection 156 is performed using simple network management protocols (SNMP), internet control message protocol (ICMP), or other management protocols as known in the art. Additional security measures can be implemented, as necessary, to further protect the transfer of sensitive information such as financial data. In one embodiment, the information transferred between the kiosk 150 and the remote service provider 154 includes database information managed by the service provider, status of the kiosk, control information, user interaction information, video, audio, text, electronic instructions to the kiosk, and so forth.

Each kiosk 150 includes hardware and software components, preferably including printers, power supplies, CPUs, coin acceptors, bill acceptors, a display screen, a cash dispenser, a change dispenser, a card swipe, etc. that operate to perform intended functions of the kiosk. The specific hardware and software components will generally differ depending on the specific function of each kiosk 150. For example, in one embodiment, a parking payment kiosk can include a small display screen that can only display alphanumeric characters but does not include a cash dispenser. In contrast, an automated car wash kiosk can include a larger display screen that displays menus and images and does include a cash dispenser. Preferably, the kiosk 150 is also equipped with additional components, such as cameras, microphones, speakers, self-diagnostic equipment, keyboards, touch panels, and the like to enable the kiosk 150, the user 152, and the remote service provider 154 to communicate with each other and to provide real-time interactive assistance to the user.

In one embodiment, the camera can tilt, pan, and zoom to communicate information regarding the physical characteristics of portions of the kiosk 152 and the surrounding area. In a preferred embodiment, the camera is a video camera and can record video of the area. In another embodiment, the video camera includes capabilities to capture infrared light (e.g., thermal vision) and to amplify light (e.g., night vision). In addition, the microphones and speakers are preferably capable of capturing and producing user speech and sounds in real time. In a further preferred embodiment, the display screen is capable of displaying video in the form of a live or virtual attendant.

The diagnostic equipment is preferably capable of collecting and analyzing information relating to the operation and status of the components in the kiosk. In a preferred embodiment, diagnostic tests of the kiosk 150 are periodically performed or performed at the request of the remote service provider 154. Any problems detected during the tests are reported to the service provider 154. In yet another preferred embodiment, diagnostic information from a number of kiosks 150A-150N is collected and displayed to the remote service provider 154 so that all of the kiosks can be easily managed at once.

The remote service providers 154 include systems that support the functioning of the kiosks 150 and the providing of interactive assistance. For example, the remote service provider manages information in a database 158 that supports the functioning of the kiosks 150. In addition, the remote service providers 154 preferably include a status module 160. The status module 160 collects information from the kiosk 150 regarding the status of the hardware and software components. In addition, the status module 160 can instruct the kiosk 150 to perform the diagnostic tests and give corrective instructions to the kiosk. Further, the status module collects information regarding interactions with the user 152. This information includes a time of day, a length of interaction, a history of the interaction, etc. In one embodiment, the history of the interaction includes actions performed by the user and by the kiosk, including, for example, a number of card swipes, the menus that the user has navigated through, and the responses from the kiosk to each of these actions. In a preferred embodiment, the remote service provider 154 uses the information to assist a user 152 by identifying the source of problems and by solving the problems by communicating instructions to the kiosk 150 and/or the user 152. In a more preferred embodiment, the remote service provider 154 uses the information to identify a user 152 that may benefit from assistance and can initiate contact directly with the user or remotely attempt to solve the issue without contacting the user. Alternatively or in conjunction, the information is used to identify the source of the problem and issue corrective instructions to the kiosk 150. In yet another embodiment, the remote service provider 154 can issue credits or dispense currency to the user 152.

In one embodiment, the kiosk(s) 150 are located at discrete locations throughout the world and provide a variety of different interactive functions. For example, the kiosk 150A can be located in Chicago, Ill. and is a parking payment kiosk and the kiosk 150N can be located in Irvine, Calif. and is an automated car wash kiosk. In another embodiment, the remote service provider is different for each type of kiosk. For example, remote service provider 154A communicates with the kiosk 150A and is different than the remote service provider 154N that communicates with the kiosk 150N. In this example, the status module 160 for different remote service providers 154 may be tailored to provide the most relevant information to the service provider for the specific kiosk 150. In another embodiment, a remote service provider 154 is the same for each of the different kiosks 150A-150N. In any of the above embodiments, the system of FIG. 4 provides an integrated system allowing one or more remote service providers 154A to manage the status of one or more kiosks 150A-150N and provide interactive assistance to users 152 at the kiosks using combinations of video, audio, status information, etc.

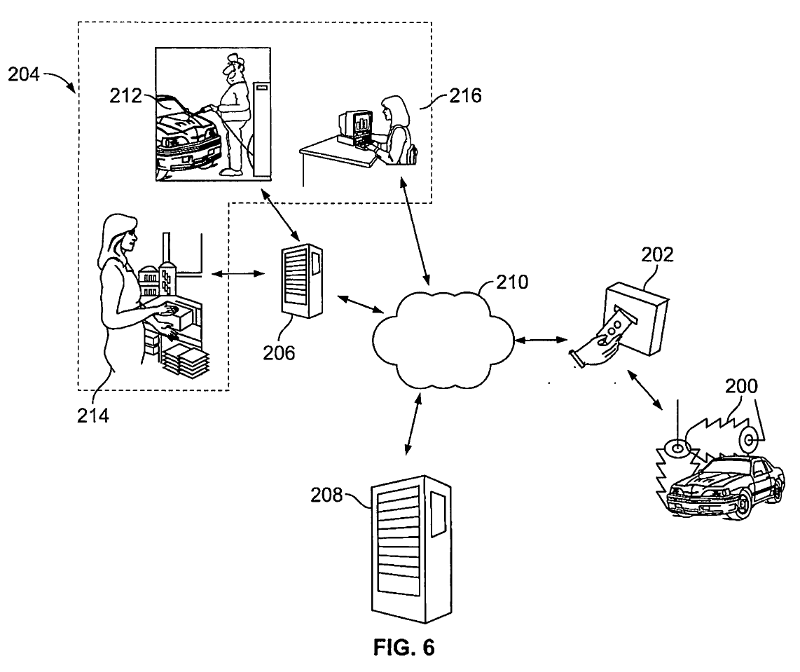

In another embodiment, as shown in FIG. 5, for example, the kiosks 150A-150N are connected through the communication connection 156 to a central server 162 that stores and processes information regarding the kiosks and the service providers 152A-152N. In FIG. 5, the central server 162 includes a status module 160 that collects information regarding the various kiosks 150A-150N and user interactions with the kiosk. The central server 162 also includes a database 158 that supports the functioning of the kiosks 150. The central server 162 uses the information collected by the status module 160 to identify problems with the kiosk 150. Such problems may be identified from monitoring the status of the kiosks, from a user initiated service call, or from monitoring interactions between the user and the kiosk.

In a preferred embodiment, the central server 162 connects the kiosk 150 and/or the user 152 with a specific remote service provider 154A-154N to solve the problem. In a more preferred embodiment, the central server 162 compares the specific problem with available remote service providers 154A-154N to select an optimal remote service provider to connect. The optimal connection of a remote service provider 154 to a kiosk 150 can be performed using any number of well-known management algorithms. For example, if the identified problem relates to hardware and software components of the kiosk 150, then a remote service provider 154, such as an equipment technician, can be selected and connected. In another example, the identified problem relates to an account question and the central server 162 connects an account supervisor to the kiosk 150. Thereafter, the remote service provider 154 provides assistance and attempts to solve the problem. After the remote service provider 154 has solved the problem or has otherwise discontinued interaction with the kiosk 150, the remote service provider is available for reassignment by the central server 162.

In another embodiment, status modules 160 are located at each remote service provider 154A-154N or at both the central server 162 and at each service provider. This embodiment allows the status modules 160 to be tailored for each type of kiosk 150 and remote service provider 154 to provide the most relevant information to the service provider. As a result, the central server 162 of FIG. 5 facilitates the management of many different kiosks 150A-150N and remote service providers 154A-154N.

In a further embodiment, the assistance provided by the systems of FIGS. 4 and 5 is provided as part of a business model. For example, the assistance may be included as part of the purchase of a product or service. In other examples, the assistance is provided free of charge, on a subscription basis, or on a pay-per-use basis.

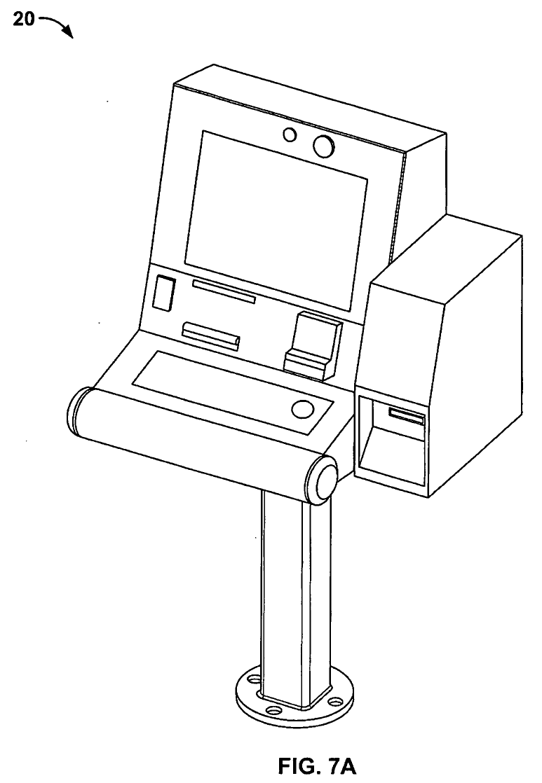

Referring now to FIG. 6, in one embodiment, a car wash system includes a car wash appliance 200, an activation unit 202, point of sale (POS) systems 204, a local server 206, and a central server 208. The car wash appliance 200, the activation unit 202, the POS systems 204, the local server 206, and the central server 208 are connected via a communications connection 210. The car wash appliance 200 includes suitable components for car washing, as are well known in the art, including automatic car wash appliances, manual car washes, and combinations thereof. The activation unit 202 is associated with the car wash appliance 200 and is capable of assisting a user in selecting the type of wash, displaying the price of the wash, completing payment for the car wash, activating the car wash appliance to wash the car, and giving instructions to the user to proceed. In another embodiment, the car wash has already been purchased by the user and the user enters a car wash entry code or access ticket at the activation unit 202. After completion of the car wash, the activation unit 202 reports the successful completion to the central server 208.

The local server 206 and the central server 208 provide functions, such as authorizing credit card or debit card payments, recording the transaction, providing the user with a wash code. The wash code is entered into the activation unit 202 to authorize the performance of a car wash by the car wash appliance 200. The wash code is one embodiment for authorizing the car wash at the activation unit 202 that includes a number of digits that uniquely identify the transaction. Other embodiments can be used to identify the transaction, such as bar codes, phone numbers, alphanumeric codes, magnetic cards, RFID tags, license plate numbers, user biometrics, etc. Further any combination of the preceding can be used to identify the transaction.

For example, the combination of a unique wash code and a specific license plate number can be used to allow repeated washes to the same car or only authorized cars. This combination is useful where a free additional wash is allowed to account for unexpected rainfall or other circumstances that deprive the user of the benefits of the initial wash. Further, in some situations a wash code is given to a category of authorized vehicles (e.g., law enforcement vehicles) or a fleet of authorized vehicles (e.g., cars of a particular rental agency or taxi cab company). Consequently, the combination of the wash code and the license plate number can ensure that only authorized vehicles are using the wash code. This embodiment, contemplates the addition of sensors at the activation unit 202 to detect the license plate number of the car.

In another embodiment, the servers 206, 208 also store revenue enhancement module (REM) information, including special discounts, loyalty programs, fleet programs, charity, and community programs. In addition, the central server 208 also processes financial information from each of the POS systems 204 and activation systems 202. The financial information includes, for example, profit margin, gross margin, net profit, etc.

The POS systems 204 offer additional locations where the user can purchase the car wash, for example, at a gas pump 212, from a cashier 214, or through an internet website 216. In a preferred embodiment, there is a plurality of car wash appliances, activation units, POS systems, and local servers located at distributed locations and the user can purchase the car wash at any of the locations and have the car wash performed at any location. In particular, the car wash can be performed at a different location than where it was purchased.

For example, the user accesses any of the POS systems 204 to purchase a car wash and selects a type of wash and payment method. The POS system 204 communicates to the local server 206 or to the central server 208 to authorize the payment and issue a wash code or other authorization for the car wash. The local server 206 and the central server 208 also store transaction information. The transaction information includes the type of car wash purchased, a wash code or other authorization method, a date of purchase, a location of purchase, REM information including a free upgrade or car wash program code, etc. In some situations, the transaction information is stored locally by the local server 206 before the information is transferred to the central server 208 via the communication connection 210. In other situations, the transaction information is transferred directly to the central server 208 without being first stored locally. In either case, the activation unit 202 periodically accesses the central server 208 and stores the transaction information. Consequently, the user can enter the wash code at the activation unit 202 and have the car wash performed by the associated car wash appliance 200 even in situations where the central server 208 is temporarily disconnected. In a preferred embodiment, all of the distributed activation units 202 store the transaction information so that the car wash can be performed by the associated car wash appliance 200 regardless of where the car wash was purchased.

Further embodiments of the disclosure follow:

The present disclosure, in the context of unattended payment systems, is directed to technology that focuses on the following capabilities:

The system provides the means to handle cash customers, i.e., by accepting cash payments, dispensing whole dollar change, and maintaining track of individual consumer's purchases in order to develop customer credits toward future purchases.

The system further interfaces with existing pump controllers to authorize fueling and update transaction logs; complies with local government (city planning, fire, etc.) regulations; and provides for necessary hardware security.

### 1. Cash Handling

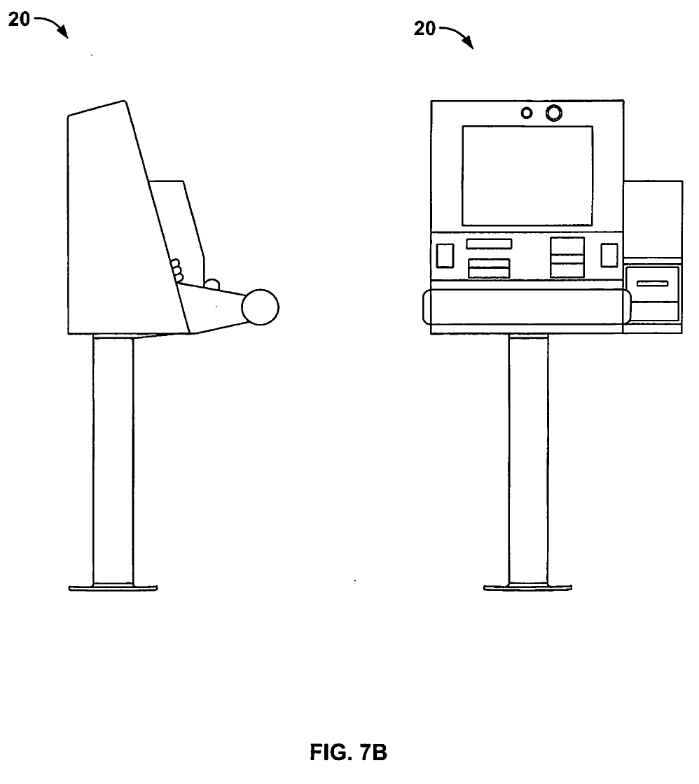

In one embodiment, this capability is addressed with a single centrally-located kiosk, such as depicted in the embodiment of FIGS. 7A, 7B, and 7C that serves all cash paying consumers. Cash paying customers are directed via signage to the kiosk. The kiosk includes the following equipment with which the customer will interact:
17″ touch screen;
Bill acceptor (US$ in 1, 5, 10, 20 denominations);
Note dispenser ($1 denomination, up to ten at one time); and
Sealed keyboard (for capturing customer profile information).

All cash customers are required to begin their transactions at this kiosk. They will be greeted by a friendly welcome screen that includes a positioning message from the system interface.

New customers are requested to press a “New Customer” button on the welcome screen, which will then begin a short safety tip video. After the video, the system will prompt the user for their name and phone number (which may be used to define a Personal Identification Number [PIN] for future transactions, for example), which is entered via the keyboard. Optionally, a sweepstakes can be used as an incentive to do so.

Existing customers (with the exception of new customers that have just signed up) will be asked to input their PIN. The system verifies the PIN as belonging to an existing customer. Once verified as an existing customer, the user will then proceed to a next screen, termed herein as a “terms of use” screen (which they can quickly accept on subsequent visits).

If the existing customer has credit for a future purchase from a previous transaction, the customer will be presented with the option of receiving whole dollar change in the form of $1 bills, with anything less than $1 remaining in credit for a future purchase, or the customer can choose to begin a new fueling transaction.

Customers who wish to begin a new fueling transaction will be prompted to select a pump number. They will be presented with an overhead representation of the station to assist in the selection.

After the pump number has been selected, customers will then be shown a payment screen with any credit from their previous transaction prominently displayed ($0.00, in the case of new customers). They will be prompted to insert bills of proper denominations into the clearly marked bill acceptor. As the bills are inserted, the current credit is updated accordingly. When finished inserting bills, the customer will press the “Pump Gas” button to move on. At this point, the system will pass a request via an “edge server” to the existing pump controller to dispense the appropriate amount of fuel.

Preferably, the Edge Server is a local computer system responsible for collecting and processing large amounts of data from various sources at the remote fueling site. Several software subsystems run on the edge server, in conventional fashion, in order to take advantage of the power of distributed processing and contextual data. Data is mined from these systems only as needed.

More preferably, the Edge Server is a 6102-based computer located within an equipment room or other designated location on-site. This server is responsible for communicating with the pump controller (CCISTech) as well as being the local data store for customer account information. It is connected with a Central System Server via a high-speed data network, such as a TCPIP based Internet connection, or other such network communication link. The definition of the communication is provided by the system at installation and may be adapted to local communication conditions by the system designer without interfering with system functionality.

In terms of the ability to interface with existing fuel pump controller systems, in one embodiment, CCISTech to used control the pumps and dispensers. Through an agreement with CCISTech, the system manufacturer will provide a CCISTech controller with dispenser, amount, and pump authorization instructions, as well as have the ability to mine transaction details (i.e., quantity of fuel pumped, amount paid, change due, and the like).

All pump transactions will continue to be logged by CCISTech. Cash transactions will be identified in the logs by a system manufacturer specific key utilizing the existing table structure provided by CCISTech. This will ensure that existing reconciliation processes in place at the system can continue without undergoing any change management.

When the request is accepted and authorized, the kiosk will inform the customer that they may begin fueling. At this point, the kiosk resets itself, ready for the next customer.

After the customer is finished fueling, the Edge Server will receive information about the transaction from the pump controller. If the transaction totaled less than the initially authorized amount, a credit for a future purchase will be saved and associated with the customers PIN for future use.

If the customer has pumped less than the amount of money initially authorized and wishes to receive change back, the customer may return to the kiosk to do so. After entering their PIN at the welcome screen, they would be presented with their change options and informed that local fire codes prohibit the dispensing of coin change at unattended fueling stations. After removing the whole dollar change that is dispensed, the kiosk would reset itself.

Customers can cancel their transaction at any point, with the customer credit, change dispensing, kiosk and pump systems reset as appropriate, depending on the status of the transaction. If the system is forced to cancel a transaction due to inactivity, pump out of order, etc, a similar flow will be followed to ensure that the customer receives the appropriate credit for a future purchase.

The customer PIN, credit for a future purchase, transaction status, etc., will be stored locally and synchronized with a “central server,” described in greater detail below, so as to ensure that customers can go to any fueling site that is implemented with the system of the present disclosure and receive the appropriate credit for a future purchase.

According to one embodiment, certain assumptions will be made:
Providing name and/or PIN will be required;
There will be no plastic ID card issued;
Signage directing cash customers to the kiosk will be specified and provided by the developers of the system;
A customer service phone number will be printed on the kiosk, with a label or sticker provided by the developers of the system;
The mandatory safety video will be less than 1 minute in length; and
Using specifications provided by the manufacturer, the user organization will be responsible for physically emptying and refilling the kiosk's bill acceptor and note dispenser cash cassettes.

The system solution will comply with the local Fire Marshal and City Planning regulations, as well as all UL and ADA guidelines.

While every consideration will be taken to promote security and prevent theft, nothing is ever 100% secured. Based on well known practices in the security and kiosk industries, all necessary and practical measures will be taken to ensure the physical security of the hardware placed on site. The kiosk is designed to be tamper resistant, with a sturdy steel enclosure, a substantial base securely bolted (with bolts welded shut) into concrete, and locked limited access doors for cash removal and refilling.

In addition, the kiosk will preferably be protected by a high-decibel siren connected to state of the art motion, shock, and tamper sensors, as well as direct dial connection to a security monitoring service.

According to this embodiment, the following assumptions have been made:
The system manufacturer will select and pay for the security monitoring service as part of the ongoing support fee;
The system manufacturer will establish alarm procedures; and
Third party money handling services will be provided kiosk access that avoids triggering the alarm.

### System Details

The system according to one embodiment consists of various hardware and software systems controlled and accessed via role-based GUI's outlined below. In order to minimize the cost of development and the time to market, common off-the-shelf (COTS) components are used wherever possible.

As described above, the edge server is a local computer system responsible for collecting and processing large amounts of data from various sources at the remote fueling site. Several software subsystems run on the edge server, in conventional fashion, in order to take advantage of the power of distributed processing and contextual data. Data is mined from these systems only as needed.

The Edge Server is a 6102-based computer located within an equipment room or other designated location on-site. This server is responsible for communicating with the pump controller (CCISTech) as well as being the local data store for customer account information. It is connected with a Central System Server via a high-speed data network, such as a TCPIP based Internet connection, or other such network communication link. The definition of the communication is provided by the system at installation and may be adapted to local communication conditions by the system designer without interfering with system functionality.

The Central Server is a computer system located at a Network Operations Center (NOC) that interacts with and mines data from the Edge Server as needed, as well as serves up information through a browser to the operational and business end users. Business logic on the Central Server will synchronize the customer data located on the Edge Servers at the various automated system sites.

The kiosk is a custom-fabricated freestanding device that provides the physical means of interaction with the customer. In one embodiment, the kiosk is a steel encased unit that contains the following equipment:
17″ touch screen;
Bill acceptor (US$: 1, 5, 10, 20 denominations, both new and old styles);
Note dispenser ($1 denomination, up to ten at one time);
Sealed keyboard (for capturing optional customer profile information);
Shock and motion sensors coupled to an alarm controller; and
Siren.

A kiosk alarm controller is a 4020 based unit which will be housed in the equipment room. It will be connected to the shock sensors on the kiosk as well as the siren, in addition to having a direct dial connection to the security monitoring service.

The alarm controller will be connected to an existing phone line in the equipment room. It does not require a dedicated line, but rather has the ability to “take control” of a land line, in a manner well understood by those having skill in the art, in the event its use is required.

### User Scenarios

The following user scenarios are meant to be an example of how a potential customer might interact with the system of the present disclosure. While not necessarily strict process flow procedures, the scenarios are nevertheless illustrative of certain steps and actions that a particular consumer may take in order to interface with the system.

First-time Cash Customer:
1. A first time cash consumer drives up to the pump.
2. Printed signs direct her to begin her cash transaction at a centrally located kiosk.
3. At the kiosk, she identifies herself as a new customer via a large touch screen.
4. She is presented with a short 30 second safety video and terms of use page. She agrees to the terms.
5. She is prompted to enter her name and phone number for account creation and identification purposes.
6. She types her name, and 10 digit phone number (PIN).
7. Her information is accepted, and she is presented with a pump selection screen.
8. She is prompted to select a pump. She selects, for example, pump #3.
9. She is prompted to insert cash, acceptable in $1, 5, 10, and 20 denominations. She inserts, for example, $30.
10. She is told her pump is now authorized, and that she may return to the kiosk if she would like to receive whole dollar change back.
11. She goes to her car and pumps $23.35 worth of fuel. She replaces the nozzle.
12. She goes back to the kiosk, selects “Existing Customer” and enters her 10 digit PIN.
13. The system identifies her and presents her with a list of options. She chooses the option to receive $6 in whole bills and $0.65 in credit for a future purchase.
14. The kiosk dispenses six $1 bills and informs her she has $0.65 available in credit for a future purchase.
15. She collects her bills, goes to her car, and drives away.
16. The kiosk resets itself, awaiting the next customer.

Returning Cash Customer
1. A returning cash consumer drives up to the pump.
2. Printed signs direct her to begin her cash transaction at a centrally located kiosk.
3. At the kiosk, she selects “Existing Customer” and enters her 10 digit PIN, which immediately identifies herself as a recurring customer.
4. She is prompted to select a pump. She selects #4.
5. She is shown that she has a current credit for a future purchase of $0.65 and is prompted to insert cash, acceptable in $1, 5, 10, and 20 denominations. She inserts $25, and is shown she has $25.65 available.
6. She is told her pump is now authorized, and that she may return to the kiosk if she would like to receive whole dollar change back.
7. She goes to her car and pumps $24.45 worth of fuel. She replaces the nozzle.
8. She gets in her car and drives away, knowing she has $1.21 available to her on her next visit.

The system of the present disclosure supports a completely automated and unattended fueling sites, while maintaining a complete transaction ability for a consumer. The central kiosk is effectively a “point of sale” (POS) system coupled to function in accord with an edge server that maintains local transactions and is responsible for collecting and processing data from various sources implemented at the automated fueling location.

Similarly, individual edge servers, disposed at various different automated fueling locations, are coupled to and communicate with a centrally located server system. The centrally located server system provides for synchronizing all the customer data located on the edge servers at the various automated system sites, and further provides for off-sites maintenance, programming changes and updates, and implementation of various marketing offers, customized user “rewards” programs, and the like, at all of the various automated system sites, or selected ones of the various automated system sites, as determined by the system management.

In a further aspect, the principles of the system of the present disclosure provide for implementation of a locally and remotely networked car wash management system. In a manner similar to the automated fueling implementation, above, the automated car wash management system is comprised of custom software and various off the shelf electronic components that are combined and connected in such a way that allows for one or more physical car washing systems to be monitored, controlled, and programmed either individually or collectively in a networked manner.

Advantageously, the system of the disclosure consists of various hardware and software systems controlled and accessed via role-based graphical user interface components (also termed GUI's) outlined below. The system is based on COTS components wherever possible.

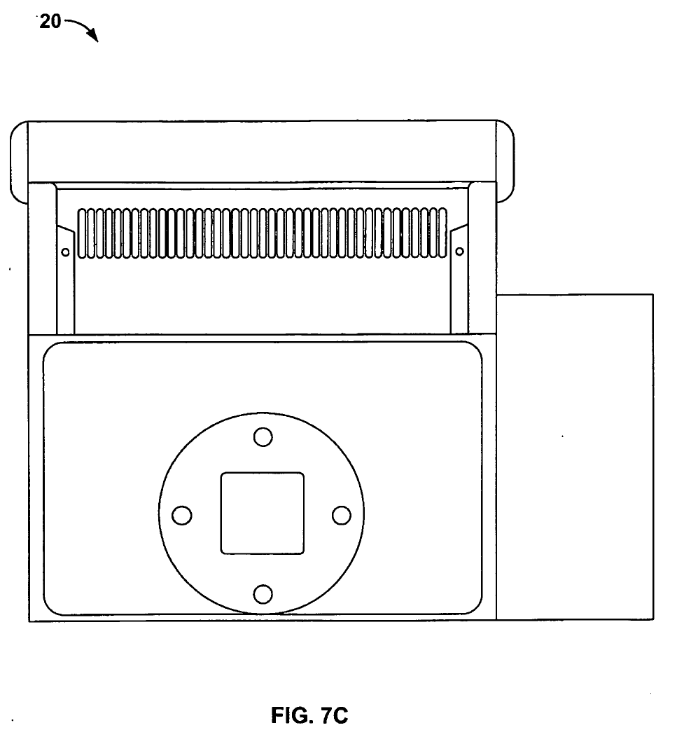

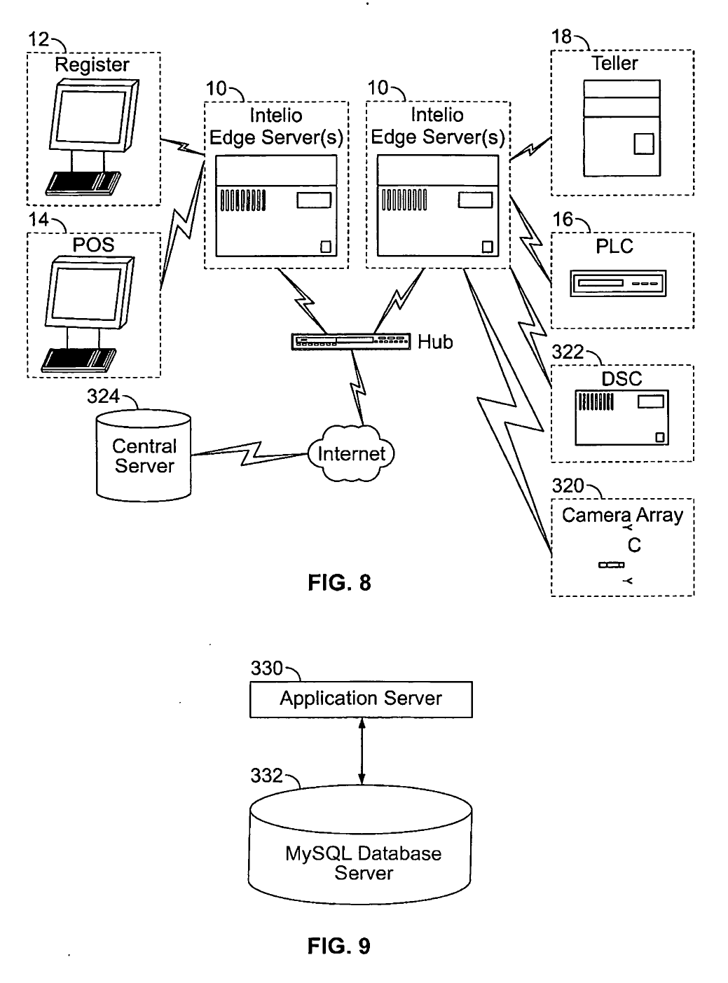

An Edge Server 10 (seen in FIGS. 8 and 9, for example) suitably comprises a 6102 platform that is a PC 104 Pentium-based single-board computer capable of running a conventional operating system such as Linux. The Edge Server 10 is disposed locally at the car wash site and is responsible for collecting and processing large amounts of data from various sources on location. In another aspect, one or more Edge Servers 10 may be implemented at each automated site, or, more commonly, an Edge Server is implemented at each of a multiplicity of automated sites and coupled to communicate with a controlling apparatus, as described in greater detail below.

The Edge Server(s) 10 is adapted to communicate with a cash register system 12 and/or a point of sale (POS) system or systems 14, an automated car wash controller system 16 (identified herein as a PLC), including, in turn, a teller 18, video and camera systems 320, alarm controller (DSC) 322, and a Central Server 324. The Edge Server 10 also functions as the local data store for transaction information. Preferably, the edge server 10 is connected with the Central Server 324 via a high-speed data network or dial-up modem, communicating via TCPIP protocols over the Internet.

A more specific implementation of the Edge Server 10 is shown in the exemplary embodiment of FIG. 9, wherein the server includes an application server layer 330 and a database server layer 332. The application server layer suitably hosts application software routines that access and process data contained in the database server layer 332. The database server layer 332 may be implemented as a MySQL database server, or any other suitable layer that gives database functionality.

The Edge Server 10 monitors communication between the register and any existing POS systems and captures wash codes generated by the POS and/or generates wash codes for use by the end consumer. It stores these codes in the MySQL database for later reference. When a car wash customer enters a valid wash code or purchases a wash at the car wash teller, the PLC begins the actual car wash process. The Edge Server monitors activity on the PLC to determine when a car wash has been initiated, and continues receiving input from the PLC as the car wash progresses.

The DSC is also connected to the PLC and receives inputs that are translated to simple text messages by the DSC. The Edge Server receives these text messages from the DSC and based on keywords triggers specific actions (such as “take a picture”). Once the car wash has been completed, the Edge Server packages the data it has gathered and sends it to the Central Server for further processing and reporting.

In the exemplary embodiment of FIGS. 8 and 9, the Application Server 330 will run various monitoring and controlling applications including:
PLCMON—monitors the registers and terminals on the PLC (via a CIM interface) to ascertain timing/duration of the car wash processes and, monitors gantry errors.
DSCMON—listens to a serial port (i.e. a serial printer board on the DSC) for text messages that contain keywords and triggers certain actions (such as “take a picture” or “send an alpha page”) based on these keywords.
FINMON—packages the data components of a transaction (pictures, timing, transaction details) along with site and transaction identifiers.
PayloadSender—sends the FINMON packages to the Central Server.
PictureTaker—instructs the camera apparatus to take a picture or motion video.
   The MySQL database server 332 stores all aspects of the transaction data being captured in conventional form and in a manner that allows for the various transaction details to be accessed by a remote processing apparatus, such as the Central Server 324 (of FIG. 8)

The Central Server 324 is a central administration console and user store for the distributed carwash management sites of the present disclosure. Central Server 324 provides a central data store for all of the Edge Servers of the distributed carwash management system. The Edge Servers, in turn, control each individual site.

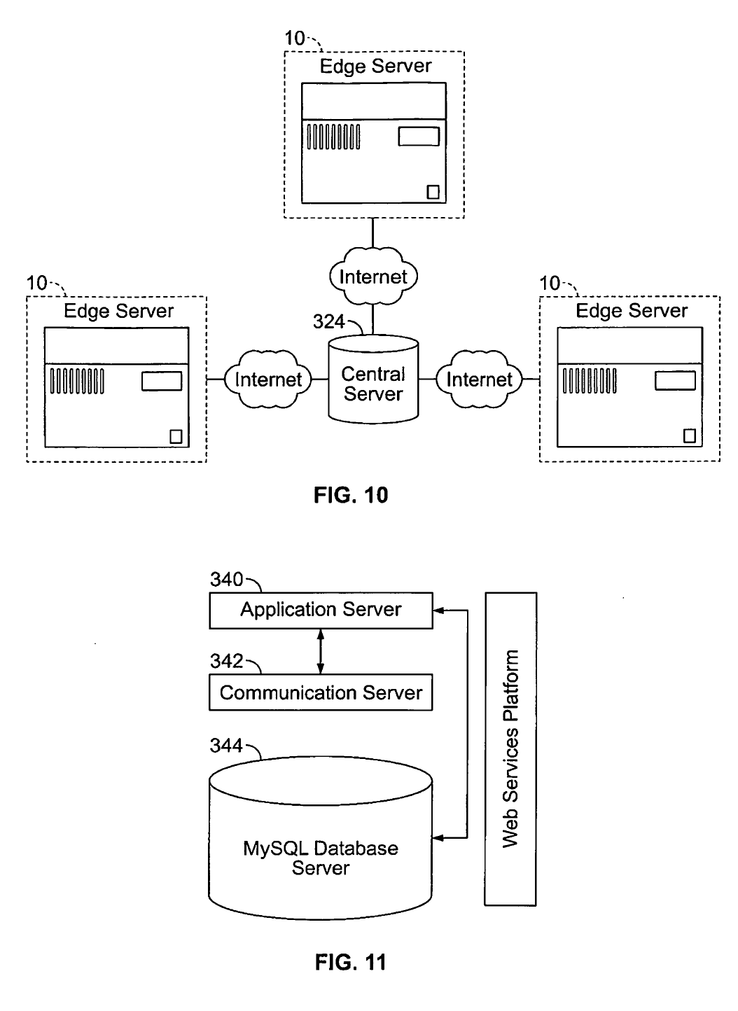

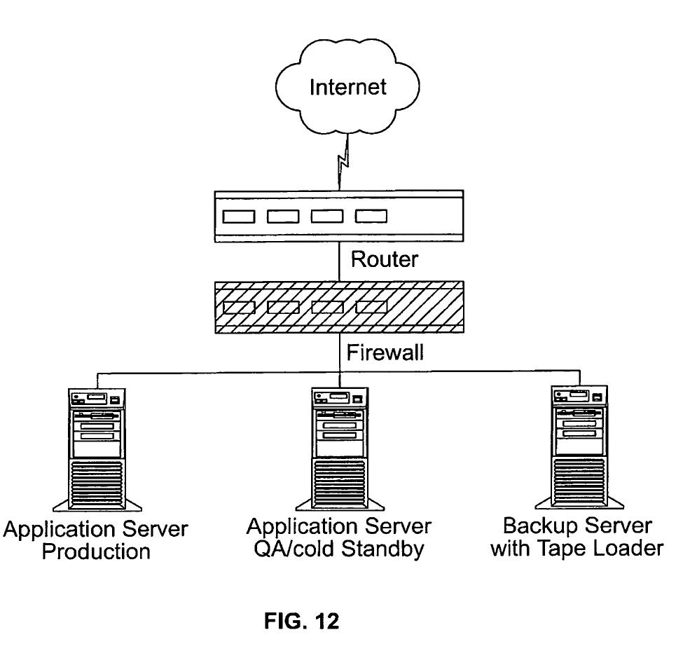

Turning now to FIG. 10, there is shown a simplified, semi-schematic block diagram of the relationship between the Edge Servers and the Central Server. In this regard, the embodiment of FIG. 11 depicts the component functional portions of the Central Server.

In the diagram of FIG. 10, an Application Server layer 340 will serve web pages to the users and control the interaction with the Web services hosted by the platform. The server will reside on top of a MySQL relational database server 344, in a manner similar to the Edge Server structure of FIG. 9. A Communication Server layer 342 manages the connections and payload communication protocols between the various Edge Servers and the Central Server.

The Central Server provides the following features and functionality:
Reporting for:
Site usage
Transaction details
A central database for customer accounts including:
Customer data
Account status
Web server that provides GUI for:
Alerts
Process status
Marketing programs

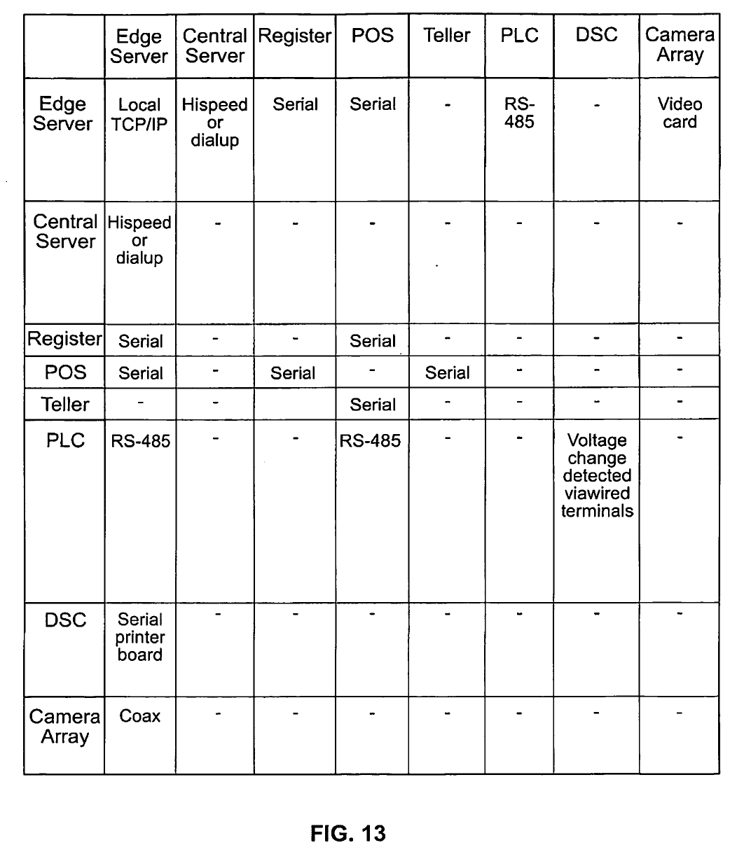

The general physical specifications of the Central Server 324 are depicted in the embodiment of FIG. 12, wherein the server architecture is shown as an array of server systems, with one server system “operational”, a second operating in parallel fashion in a “quality assurance” mode, and a third disposed as a “backup” system in case of operational failure of either the primary server or the QA server.

Both a firewall and router are provided and may be implemented as a single physical device, even though they are depicted as two separate components in the embodiment of FIG. 12.

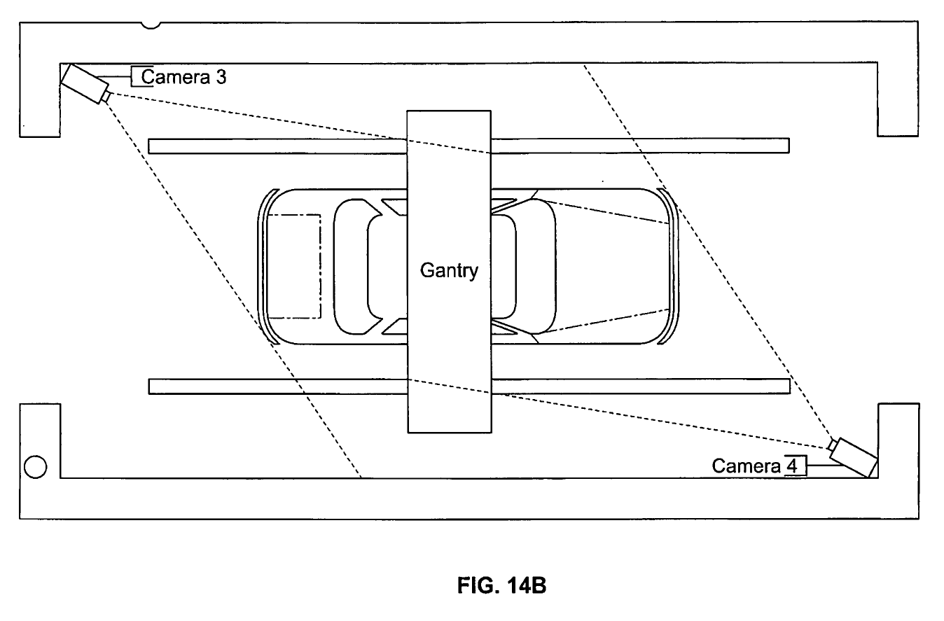

A camera array is comprised of strategically located still and/or video cameras (best seen in the embodiment of FIGS. 14A and 14B) that are operatively controlled by application software routines hosted on the Edge Server. The images captured by these cameras are stored locally and are associated with a key (or other suitable code designation) that allows them to be associated with other pertinent customer or transaction information.

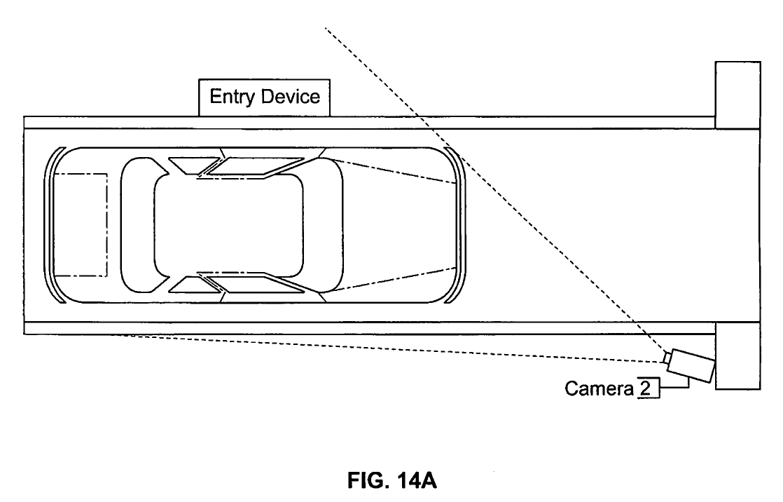

The communication methodologies of communication between and among the various components of the system in accord with the disclosure are depicted in the exemplary table of FIG. 13. It should be understood by those having skill in the art that the communication methods and protocols are for purposes of example only and may be interchanged with many other communication methods and protocols without departing from the spirit and scope of the disclosure. For example, wired interfaces, such as RS-485, may be replaced with wireless interface, such as “Bluetooth” or “802.11” by making simple, well understood programming changes, and utilizing the appropriate interface hardware.

Car wash volume is under-optimized, yet operators typically view minimizing downtime as the primary means of increasing revenue, rather than finding ways to proactively acquire new customers and build loyalty over time.

Volume sales program to organizations with a large pool of potential car washers are largely untapped due to lack of management and reporting tools needed to cost-effectively offer such programs. With the right tools and a modest sales effort, car wash operators can proactively market volume purchase programs to drive incremental revenue at profit margins higher than those achieved at the gas pumps or in the c-store. In accord with the disclosure, a Revenue Enhancement Module (termed herein REM) provides operators with those tools and allows them to sell charity, fleet and promotional marketing programs that acquire new customers and give these new customers an incentive to keep coming back.

Adding a program tracking code to the workflow of a customer purchase transaction is the key to the management of a virtually unlimited number of REM programs. The code facilitates tracking of wash transactions associated with a charity, fleet or promotional program and drives the reporting that the operator needs to document activity to the program's partner. The difference among the programs comes in the action taken by the distributor on the information reported:
Charity—the operator periodically reports activity under the program, calculates a charitable donation due ($x per transaction, for example), writes a check to the charity, and accrues a tax benefit.
Fleet—the operator periodically reports transactions to the fleet operator as backup to invoicing under the terms of the fleet agreement.
Promotional—the operator periodically reports transactions associated with the promotion to assess the business impact and ROI of the program, and to calculate and report any revenue sharing due to the promotion's business partner (if any). Examples would be a nearby Jiffy Lube running a cross-selling promotion or the operator selling discounted washes via a rechargeable wash card.

The commonality of REM programs simplifies the development of the software and underlying data structure required to support them. A REM tracking code field added to the standard transaction record, when tied to a table that includes REM program type and details on the program partner, leverages a data-driven interface that reads the program type and serves up data into a WashNet user interface under appropriately branded REM reports. As used herein, the term WashNet refers to the system according to one embodiment of the disclosure. Notably, the term, and the focus of the REM program, is not limited to the automated carwash system, but may be easily expanded to encompass the automated fueling system described above. Accordingly, when the transaction is described in terms of a wash transaction, it will be understood that the term also refers to a fueling transaction, or a combination of the two transaction types.

WashNet will typically utilize three identification methods in order to promote a REM program and initiate/track a wash transaction:
Cards—Plastic or paper magnetic stripe cards swiped through a WashTeller card reader apparatus.
Coupons—Pre-printed coupons/certificates with bar codes and insertable into a WashTeller bill acceptor apparatus.
Codes—A 4-digit (or more) code entered into a WashTeller keypad separately from the wash/fuel ID code.

Thus, the system enables a virtually unlimited number of REM programs to be managed simultaneously. REM programs can be set up remotely for multiple sites via the WashNet interface, and a plurality of sites may implement one REM program, while other sites may implement a different REM program.

Use Case: Cards and Coupons
Operator buys cards/coupons from Intelio (new customers get starter kit).
Operator either sells cards/coupons to REM program partner pre-paid at a discount or gives cards/coupons to REM program partner at no charge which are redeemable for a discount and/or charitable donation at the WashTeller.
REM program partner sells or gives cards/coupons to its constituents.
Constituent greeted by welcome screen on WashTeller and prompted to deposit cash or swipe credit card.
Car wash customer swipes card through card reader or inserts coupon into bill acceptor.
Depending upon specific REM program terms, either a free wash (for pre-paid), discounted wash, or full price wash (for non-discounted fleet and charity programs) is executed.
REM transaction is tracked and reported under the appropriate program within the WashNet interface.
Operator reports transactions to program partner as dictated by the terms of the operator's agreement with the partner.

Card Management

Car wash operators purchase pre-printed and pre-encoded magnetic stripe cards in bulk. Each card is printed with a unique (typically eight-digit) serial number; the same serial number is also encoded on the magnetic stripe of the card. When the operator creates a new REM program, the serial number for each card issued is associated with that REM program. Encoding the magnetic stripe card with a unique serial number allows the operator and REM program partner to detect and manage fraudulent use of wash cards; disable individual fleet cards in the event of theft or misappropriation; and modify existing REM programs without requiring issuance of new cards.

Each card can be associated with only one REM program, and for fleet programs, a unique, four-digit personal identification number can be assigned to each card issued but is not required.

Coupon Management

Currently, prior art-type coupon programs are typically capable of accepting only three different types of coupons. Each coupon can be configured in a variety of ways, but they cannot be configured to be unique to a particular operator. The system in accord with the present disclosure is capable of configuring coupons to provide the necessary uniqueness for tracking and operator designated specific REM programs.

REM Program Management

Car wash operators will have the ability to create, modify, and delete customized REM programs through the WashNet user interface. Each REM program may be associated for use at an individual site, a select group of sites, or for use at all of the operator's sites.

The operator can configure the REM program as any of the three types of programs: charity, fleet, or promotional. Each program can be set to a specific wash type (if applicable) for use on a specific day or days of the week. For charity and promotional programs, the operator can set an expiration date for the program if desired. The program can also be configured for pre-paid, declining balance accounts, discounted washes, or full-price washes. Car wash transactions attributed to a REM program will be flagged with the appropriate identifier for that program.

The operator can modify existing REM programs and disable or re-enable programs at any time through the WashNet user interface.

Upon entering the REM portion of the WashNet user interface, the operator is presented with all REM programs, active and inactive. The list of programs shows cumulative accounting data that the operator can view over specified date ranges. The operator can filter the list of programs to show, for example, only fleet programs, promotions, active, or inactive programs.

The operator can ‘drill-down’ into individual REM programs to see detailed transaction data (including car wash images), modify the terms of the program, or add, disable or re-enable individual mag stripe cards associated with the program.

Reports

Car wash operators will have the ability to download detailed transaction data for each REM program through the WashNet user interface for accounting, invoicing, and security purposes. Downloads are available in comma-separated values (CSV) files for import into spreadsheet applications such as Excel. The types and format of the reports will be specified with input from WashNet customers but, in general, will consist of transaction reports, cumulative accounting reports, and mag stripe card usage reports over specified date ranges.

### Wash Teller

The WashTeller is contemplated as comprising a standard Unitec WashSelect II with bill acceptor, credit card reader, voice processor, and proximity sensor options added, as well as a custom Mark VII WashTeller overlay (face plate).

In a further aspect, the system of the present disclosure is adaptable to support additional functionality, such as enabling entry of 4-digit REM program code at WashTeller keypad; adding voice prompts and responses to improve customer experience; and enabling use of rechargeable wash cards. This functionality allows an operator to manage discounts (REM programs) by day of week and time of day, enable sale of rain insurance and add a remote wash capability (i.e., sell a card, coupon, or code at non-car wash site, and redeem at car wash site).

Use Case: Codes
Operator gives program partner unique REM code.
Partner distributes/publishes code to constituents with list of car washes where the code is valid.
Customer greeted by welcome screen on WashTeller and inputs REM code.
WashTeller acknowledges REM program code and partner name using voice processor.
Customer confirms, selects wash type and makes payment (except pre-paid or billed fleet accounts).
REM transaction is tracked and reported under the appropriate program within the WashNet interface.

Use Case: Rechargeable Wash Cards
Operator buys quantity of cards with serialized/numbered magnetic stripes and operator's branding.
Operator sells cards in c-store for either cash or credit card (e.g. $50 worth of washes for $39.95). Under the credit card scenario, operator gives customer the option of automatically recharging to a fixed amount (e.g. $50) each time the balance dips below the price of the selected on a future transaction.
Customer swipes card at WashTeller and selects wash type.
Wash is executed and account is debited with discounted price of the wash selected.
REM transaction is tracked and reported under as a promotional program within the WashNet interface.

Use Case: Remote Wash
Operator sells wash code in c-store or at gas pump of non-car wash site.
Customer enters code into WashTeller at car wash owned by same operator and executes car wash.

Code Management

Managing four-digit codes will use the same REM program management user interface as created for Phase 1; the option of assigning a four-digit code will be added to the REM program creation workflow. When assigning four-digit codes, a check must be made against the database to ensure the operator has no other REM programs utilizing that same code.

When a code is entered into the WashTeller, a check is made against a local database and the transaction is flagged with the appropriate REM program identifier.

Rechargeable Wash Card Management

Using the REM program management user interface, Car wash operators can configure an unlimited number of mag stripe cards to be used as pre-paid, declining balance wash cards. At the customer's option, any of these cards may be designated as rechargeable wash cards. To activate a rechargeable wash card, the customer must complete and sign an authorization form (the authorization form includes the serial number of the wash card issued). Upon receipt of the authorization form, credit card processing technicians will configure the record in the database to recognize the wash card as rechargeable. Once the card reaches a low-balance threshold, a credit card transaction is automatically submitted in an amount appropriate to restore the card to full face value. Upon approval of the credit card transaction, the database will be updated to reflect the new balance for the card.

Car wash transactions purchased with a rechargeable wash card will be flagged with the appropriate REM program identifier. For each transaction, the database will be updated to reflect the new balance for the card.

Remote Wash Management

When a car wash is purchased at a remote site, a unique remote wash code is printed on the customer's receipt. When the remote wash code is redeemed at one of the pre-designated car wash sites, a message is sent to the other car wash sites that the code has been redeemed and is no longer valid.

The remote site will appear in the WashNet user interface Site List, but remote sites will not show operational or security status information. Also, site management functionality will be disabled for remote sites.

On the remote site's accounting page, the wash mix will be shown for purchases made at remote sites, but gross revenue, estimated costs, and estimated gross margins will be disabled; gross revenue, estimated costs, and estimated gross margins will be reported for the site at which the remote wash code was redeemed in order to simplify operator accounting issues.

Reports

Car wash operators will have the ability to download detailed transaction data for each REM program through the WashNet user interface for accounting, invoicing, and security purposes. Downloads are available in comma-separated values (CSV) files for import into spreadsheet applications such as Excel. The types and format of the reports will be specified with input from WashNet customers but, in general, will consist of transaction reports, cumulative accounting reports, and magnetic stripe card usage reports over specified date ranges.

Numerous modifications to the present disclosure will be apparent to those skilled in the art in view of the foregoing description. Accordingly, this description is to be construed as illustrative only.

We claim:

1. A kiosk comprising:
a front panel defining an opening in a body;
an interactive screen positioned within the opening;
a moisture resistant support structure disposed between the front panel and the interactive screen; and
a central processing unit disposed within the body, wherein the central processing unit is operatively connected to the interactive screen.

2. The kiosk of claim 1, further including a plurality of secured compartments disposed within the body having varying levels of security, wherein only authorized users have access to the secured compartments.

3. The kiosk of claim 2, wherein the secured compartments are secured by electronic or mechanical locks.

4. The kiosk of claim 1, wherein the central processing unit is operatively connected to a remote network.

5. The kiosk of claim 1, further including a data storage that records data when a user attempts to access any of the secured compartments.

6. The kiosk of claim 1, wherein the central processing unit generates an alarm or activates a camera to record an image of an unauthorized user when the unauthorized user attempts to access any of the secured compartments.

7. The kiosk of claim 1, wherein the interactive panel is disposed within a groove in the support structure and is connected to the groove structure along a periphery of the interactive panel.

8. The kiosk of claim 1, wherein the interactive screen is a resistive or capacitive touch panel that detects a parameter of a user's finger.

9. The kiosk of claim 1, wherein the interactive screen is a resistive or capacitive touch panel that detects a parameter of a conductive pen.

10. The kiosk of claim 1, wherein the parameter of the user's finger is a location of the user's finger, a pressure exerted by the user's finger, or a biometry of the user's finger.

11. The kiosk of claim 9, wherein the parameter is the biometry of the user's finger and the parameter is used to determine which of a plurality of secured compartments having varying levels of security the user has access to.

12. The kiosk of claim 9, wherein the location of a user's finger is used to determine a subsequent action.

13. The kiosk of claim 1, further including one or more of a speaker, a card reader, a key reader, a retinal scanner, a cash tray, and a coin slot disposed on the front panel.

14. A method of providing customer support at a point of sale, comprising the steps of:
providing an activation unit for a customer to select a transaction;
providing a product dispenser, wherein the product dispenser is communicatively connected to the activation unit;
authorizing the product dispenser to dispense a product based on the selected transaction;
providing a server that monitors the activation unit and the product dispenser;
sensing a need for customer assistance at the activation unit or the product dispenser; and
providing customer assistance to the customer.

15. The method of claim 14, wherein the server monitors the activation unit from a remote location.

16. The method of claim 14, wherein the step of authorizing the product dispenser further includes a step of verifying that the customer is authorized to purchase a product.

17. The method of claim 14, further including a step of dispensing a coupon to a customer.

18. The method of claim 14, wherein the step of providing assistance to the customer includes a further step of providing assistance from a remote service provider.

19. The method of claim 18, wherein the remote service provider interacts with the customer by video.

20. The method of claim 18, wherein the step of providing assistance to the customer includes a step of issuing credits for a future purchase to the customer.

21. The method of claim 18, further including a step of generating a report based on data gathered from monitoring the activation unit.

22. A method of selling a car wash comprising the steps of:
providing a first car wash appliance and a first activation unit at a first location;
providing a second car wash appliance and a second activation unit at a second location that is different from the first location;
providing a first point of sale system at the first location; and
providing a central server that is communicatively connected with the first and second car wash appliances, the first and second activation units, and the first point of sale system.

23. The method of claim 22, further including a step of selling a car wash at the first point of sale system and a step of permitting redemption of the car wash at the second car wash appliance.
